(19) United States
(12) Patent Application Publication
(10) Pub. No.: US 2009/0149971 A1
(43) Pub. Date: Jun. 11, 2009

(54) INTELLIGENT MEDICAL CONSUMABLES

(75) Inventors: Bradford Siff, Westport, CT (US); John Carter, Belle Harbor, NY (US)

Correspondence Address: DICKSTEIN SHAPIRO LLP, 1177 AVENUE OF THE AMERICAS (6TH AVENUE), NEW YORK, NY, 10036-2714, US

(73) Assignee: BIOWAVE CORPORATION, Westport, CT (US)

(21) Appl. No.: 12/330,353

(22) Filed: Dec. 8, 2008

Related U.S. Application Data
(60) Provisional application No. 60/992,885, filed on Dec. 6, 2007.

(51) Int. Cl. G05B 9/02

(52) U.S. Cl. 700/79

(57) ABSTRACT

The present invention is directed to a host device and an associated consumable item that electronically communicates with the device. Exchanged information between the device and attachment is used to prevent improper device operation, limiting injury and ensuring reliable and proper operation. Communication between the host device and consumable electrodes allow for the continuous monitoring and adjustment of therapeutic electrical signals, ensuring the accurate and safe delivery of therapeutic energy into deep tissue. Embodiments include consumable items that exchange information including a physical type, a status, and/or quality control standards of the consumable item. Embodiments include an assembly or group of consumables that can communicate among themselves and with a host device; performing fixed or varied tasks for one another and/or the host device. Embodiments of the consumable item include medical consumable items. Methods of operation thereof are also disclosed.

### CROSS REFERENCE TO RELATED APPLICATIONS

This application claims the benefit of U.S. Provisional Patent Application No. 60/992,885, filed Dec. 6, 2007, entitled “Intelligent Medical Consumables,” which is incorporated by reference herein.

### FIELD OF THE INVENTION

Embodiments of this invention relate to consumable items and processing used to determine and ensure proper use of the consumable items. In particular, the field is in consumable medical items.

### BACKGROUND OF THE INVENTION

Many devices utilize consumable attachments as interfaces with the outside world. In addition, many of today's stand-alone items are also consumable. Consumable items are limited by the number of times they can be used, usually before some important component of the item is likely to fail, rendering the item either unreliable or dangerous. In some instances, items used for medical purposes can only be used once due to sterility requirements. Additionally, many consumable items have a limited shelf life after its date of manufacture, dictated by manufacturing processes and materials used. Use of these items beyond their shelf life may cause deleterious effects.

Some consumable items are part of a family of attachments used with a device, each attachment having different characteristics, but having a similar form-factor. The interchangeable form factor often leads to user confusion when determining the appropriate attachment for a particular task. As an example, blood pressure monitors are available with interchangeable transducers, each transducer providing different full-scale pressure ratings, despite having a similar appearance. Even if the attachments differ in labeling or coloring, a physical similarity can lead the user to override the label or coloring cues, and lead to an improper attachment's use and hence, incorrect device operation.

Even if consumable attachments are used properly, the attachment might have been damaged in way that cannot easily be detected. This too can lead to improper device function or in some cases device failure. One final and more subtle problem is related to the use of an inferior attachment. An inferior attachment may not be approved for use with a host device. Sometimes a less expensive device or attachment, having poor quality control (QC), or worse yet, a defective, counterfeit device or attachment is substituted. The problems that can arise from this substitution are many-fold, including poor or improper or even dangerous device operation.

Accordingly, there is a need for a consumable device that can mitigate or eliminate the drawbacks of the prior art.

### SUMMARY OF THE INVENTION

The present invention is directed to a host device and an associated consumable item that electronically communicates with the device. Exchanged information between the device and attachment is used to prevent improper device operation, limiting injury and ensuring reliable and proper operation. The present invention overcomes the deficiencies of the prior art in several ways.

In one aspect, the present invention is directed to a method for managing use of a consumable item, the method comprising: connecting a host device to the consumable item; receiving status information from the consumable item at the host device, wherein the status information is based on an electrical property of the consumable item; determining whether the consumable item is a valid item based on the status information received; and permitting operation of the host device with the consumable item based on the determination whether the consumable item is a valid item.

In another aspect of the present invention, the method further comprises rejecting the consumable item if the consumable item is an invalid item.

In another aspect of the present invention, the status information represents conductivity of the consumable item.

In another aspect of the present invention, the status information represents usage of the consumable item.

In another aspect of the present invention, the consumable item is validated if a usage limit is not exceeded.

In another aspect of the present invention, the usage limit is a number of uses.

In another aspect of the present invention, the usage limit is an amount of time of use.

In another aspect of the present invention, the status information represents a date of manufacture of the consumable item.

In another aspect of the present invention, the determination whether the consumable item is a valid item comprises checking a manufacturer's code to ensure proper quality control standards are met.

In another aspect of the present invention, the status information represents a size of the consumable item.

In another aspect of the present invention, the method further comprises adjusting the operation of the host device based on information supplied by the consumable item.

In yet another aspect, the present invention is directed to an intelligent consumable item comprising: a microcontroller configured to communicate with a host device, comprising: a writable memory; a read-only memory; and a communications transceiver; and a device having an electrical property; wherein the electrical property represents a status of the consumable item.

In another aspect of the present invention, the electrical property represents usage of the consumable item.

In another aspect of the present invention, the electrical property represents a conductivity of the consumable item.

In another aspect of the present invention, information is stored in the consumable item and is communicated to the host device that represents a manufacture date of the consumable item.

In another aspect of the present invention, the microcontroller is further configured to communicate information to another consumable item.

In another aspect of the present invention, the item further comprises a transducer for monitoring a physiological parameter.

In another aspect of the present invention, the item further comprises a gel-based electrode.

In another aspect of the present invention, the item further comprises a percutaneous electrode array.

In yet another aspect, the present invention is directed to a system for use with an intelligent consumable item, the system comprising: a host device comprising a programmable interface controller; a data transfer system; and a consumable item comprising a memory, wherein the programmable interface controller is configured to receive information stored in the memory of the consumable item via the data transfer system and to prevent use of the item if the information does not meet predetermined criteria.

In another aspect of the present invention, the programmable interface controller updates the memory in the consumable item based on a number of times the item has been used.

In another aspect of the present invention, the programmable interface controller adjusts operation of the host device based on the information stored by and received from the consumable item.

In another aspect of the present invention, the information stored in the memory of the consumable item indicates a status of the consumable item.

In another aspect of the present invention, the predetermined criteria include usage criteria.

In another aspect of the present invention, the predetermined criteria include characteristics of the consumable item.

### BRIEF DESCRIPTION OF THE DRAWINGS

FIG. 1 is a schematic diagram that illustrates a preferred embodiment of a consumable medical item comprising a circuit that is capable of communicating the physical type and state of the item to a host device;

FIG. 2 is a schematic block diagram that illustrates an exemplary host device;

FIGS. 3A-3B are diagrams that illustrate a preferred embodiment of a consumable medical item 300 comprising a percutaneous electrode array that includes an adhesion layer and a resistor; and

FIG. 4 is a flow chart that illustrates a preferred method of managing the use of a consumable item.

### DETAILED DESCRIPTION OF THE INVENTION

The present invention is directed to a host device and an associated consumable item that electronically communicates with the device. Exchanged information between the device and attachment is used to prevent improper device operation, limiting injury and ensuring reliable and proper operation. Communication between the host device and consumable electrodes allow for the continuous monitoring and adjustment of therapeutic electrical signals, ensuring the accurate and safe delivery of therapeutic energy into deep tissue. Embodiments include consumable items that exchange information including a physical type, a status, and/or quality control standards of the consumable item. Embodiments of the consumable item include medical consumable items. Methods of operation thereof are also disclosed.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

As a computer may be used to perform the steps in any claimed method, any suitable device for performing computations in accordance with a computer program may be used. Examples of such devices include a personal computer, a laptop computer, a microprocessor, a programmable logic device, programmable interrupt controller, field programmable gate array or an application specific integrated circuit.

Similarly, the software elements of the present invention may be implemented with any programming or scripting language such as C, C++, C#, Java, COBOL, assembler, per, Visual Basic, python, CGI, PHP or the like, with the various algorithms being implemented with any combination of data structures, objects, processes, routines or other programming elements. The object code created for the computing devices can preferably be executed by any general purpose computer such as a personal computer having an appropriate operating system, or a programmable interface controller.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a computer, as described above, to produce a machine, such that the instructions that execute on the computer or other programmable data processing apparatus create means for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

### EXEMPLARY EMBODIMENTS

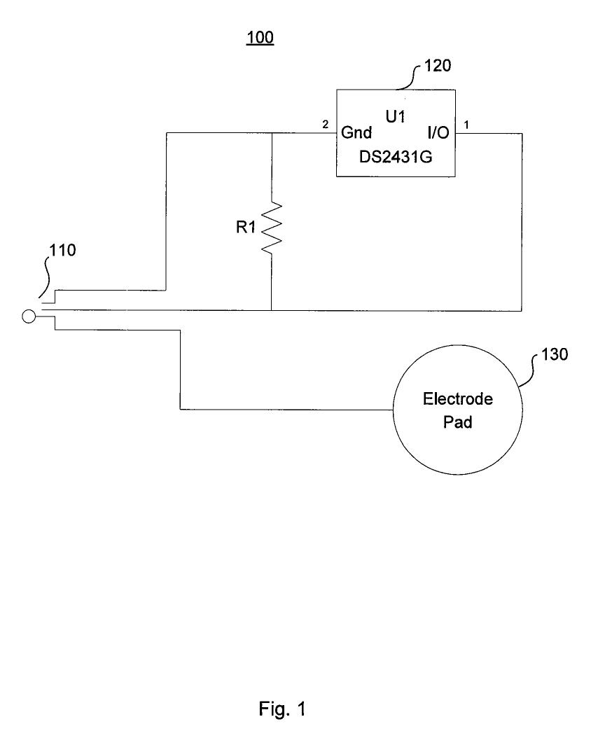

FIG. 1 is a schematic diagram that illustrates a preferred embodiment of a consumable medical item 100 comprising a circuit that is capable of communicating the physical type and state of the item to a host device. As shown in FIG. 1, the item comprises a connector 110, an electronically erasable, programmable read-only memory (EEPROM) 120, and a gel-based electrode pad 130. Connector 110 provides an electrical interface between the consumable medical item 100 and a host device (not shown). In a preferred embodiment, EEPROM 120 is a 1024 bit, 1-wire EEPROM, part No. DS2431, manufactured by Maxim Integrated Products, Inc., 120 San Gabriel Drive, Sunnyvale, Calif. 94086. EEPROM 120 stores information that uniquely identifies item 100, and information concerning the state of item 100. Gel-based electrode pad 130 is attached to a patient, to provide an electrical interface between the host device and the patient. As mentioned above, gel-based electrode pad 130 has an electrical property of item 100 that affects the operation of the host device. For example, the area of the gel-based electrode pad 130 directly determines the maximum allowed power that can be applied to the patient. In an exemplary embodiment, information identifying the area of the gel-based electrode pad is stored in EEPROM 120.

In yet another embodiment, the number of times that item 100 has been used is a proxy for the amount of time that gel-based electrode 130 has been exposed to air. As gel-based electrode is exposed to air, it dries out. Thus, the state of item 100 depends upon its exposure when being used. The moisture content of gel-based electrode 130 affects the electrode's conductivity and its ability to adhere to skin. The gel used with these electrode pads dries over time diminishing the pad's conductivity. Pad conductivity also drops with each use from the accumulation of hair, oils and skin particles. As the conductivity diminishes so does the total power that can be achieved.

Additionally, poor adhesion can cause similar problems and can in some circumstances lead to high instantaneous power densities that can cause discomfort. After a certain number of uses, the electrode pad may form a discontinuous bond with the skin which will cause a rise in power density and can possibly lead to injury, e.g., a burn. The loss of adhesion can lead to a less efficacious treatment since the proper electric field can not be established. In a preferred embodiment, the number of uses of a set of gel-based electrode pads, conducting the signals from an electrotherapy device to the skin, is deliberately limited. This is necessary to ensure that proper adhesion and good electrical contact are maintained during a treatment. Because the pad is preferably limited to five, 20-minute uses (100 total minutes of accumulated use), information identifying the number of times that item 100 has been used is stored in EEPROM 120.

In yet another exemplary embodiment, information identifying the time of first use of item 100 is store in EEPROM 120.

In operation, software and hardware in the host device is programmed to respond automatically and appropriately to the pad's state. Depending upon the information provided by the pad, the host device can permit use of item 100 with the host device, operationally lock-out use of the host device, update a “number of use counters,” or select an allowed output power range.

In more detail, an electrically modifiable consumable that can convey its state and identifying information to a host device. The host device is capable of interpreting this information and acting accordingly.

For example, the exchanged information can comprise: the type or model of the consumable item; the physical condition of the consumable item; the operational characteristics of the consumable item; an identification of the manufacturer of the consumable item; the expiration date for the consumable item; and/or the number of times used and the maximum number of uses allowed for the consumable item.

In the exemplary embodiment illustrated in FIG. 1, as mentioned above, item 100 comprises a gel-based electrode pad 130. Pad 130 is preferably limited in time. Additionally, the electrodes are available in several different areas, each of which supports the application of a different allowed total power. A memory in EEPROM 120 holds the current accumulated use-time as updated by the host device, a device ID for QC and information as to its size. This memory communicates over a one wire digital interface with the host device's processor. The host device sets the allowed power levels based on the information contained within the pad's memory. The host device also keeps track of accumulated use time and updates the pad's timer appropriately.

In another electrode design, described in more detail below, a percutaneous electrode array (PEA), must only be used once due to sterility requirements.

Both electrode-types are available in different sizes. Each size is limited, by the permissible power density, in the maximum power it can transfer. Ideally, the host device can determine the maximum power that it can deliver to the consumable electrode based on the area of the attached electrode. It would be less than optimum and much less efficacious to set the maximum output power to the power density associated with the smallest electrode. Additionally, both electrode pad types undergo rigorous and traceable QC. It is imperative that the electrotherapy device functions with only pads that meet rigorous QC testing protocols.

If the consumable is part of a set of consumables that need to be properly selected, the consumable must identify the configurations that are allowed with the particular family of companion devices.

In a preferred embodiment, consumable medical item communicates with a host device by either using: a set of wire(s) to supply power and exchange information; modulated radio frequency (RF) signals to supply power and exchange information; modulated RF signals to exchange information with a self contained battery to supply power; or either unidirectional or bidirectional optical signals, as appropriate, to convey information using either a fiber optic construct or free space propagation.

In yet another preferred embodiment, a host device searches electronically, either by wire, radio or optical means for the consumable medical item.

In yet another preferred embodiment, the device or consumable medical item communicates with a host device either by wire, radio or optical methods or communicates between consumable medical items, using modulated RF signals or modulated and/or discrete wavelength optical signals to exchange information and share computational tasks.

A host device can query and respond to information of the type outlined above. Further, the host device has the ability, as appropriate, to return data to the consumable. The physical form of communication can be in the form of a direct-wired connection, optical method either guided or unguided, or via radio.

A software and hardware construct within the host device acts upon the information received from the consumable medical item. This feature extends to warning and functional lock-out if necessary. The construct allows the modification of data stored within the device or consumable medical item.

A consumable item can use an electrically alterable memory circuit which can be read and modified by the host device; a microcontroller or similar control circuit to examine the attachments state and exchange information with a host device; a mask-programmed memory circuit containing static information; a unique ID number assigned to each consumable item that is used as a lookup index to locate its characteristic information; or an electrical parameter including but not limited to parameters such as resistance, capacitance or inductance of a specific value and tolerance to identify the consumable medical item.

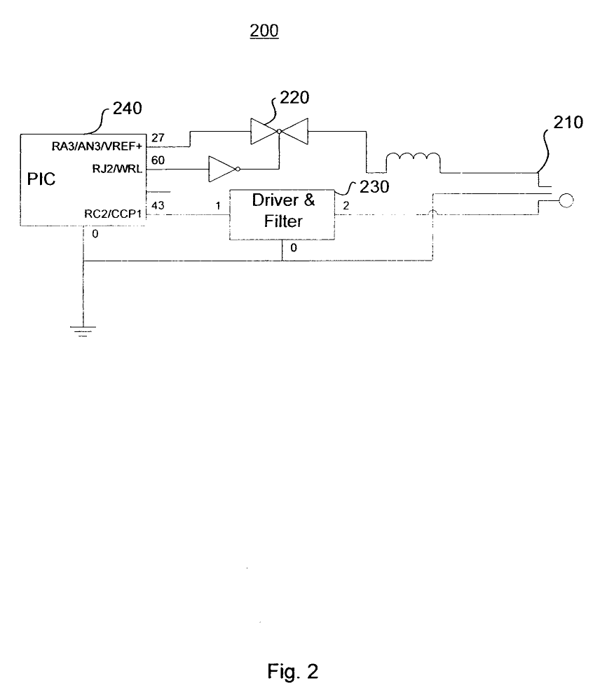

FIG. 2 is a schematic block diagram that illustrates an exemplary host device 200. As shown in FIG. 2, host device 200 comprises a connector 210, a filter and signal driver circuit 220, a tri-state driver circuit 230, and a programmable interface controller (PIC) 240. Connector 210 provides an electrical interface between host device 200 and a consumable item (i.e., consumable item 120 of FIG. 1), for example, a consumable medical item. PIC 240 generates electro-therapy signals that are conditioned by filter and signal driver circuit 220 and then fed through connector 210 and the gel-electrode pad in the interfaced consumable medical item to provide therapeutic treatment to the patient. PIC 240 reads signals and writes signals through tri-state driver circuit 230 through connector 210 to the interfaced consumable medical item. In a preferred embodiment, PIC 210 communicates with an EEPROM in the interfaced consumable medical item. PIC 210 stores information received from the interfaced consumable medical item that uniquely identifies the item, and information concerning the state of the item.

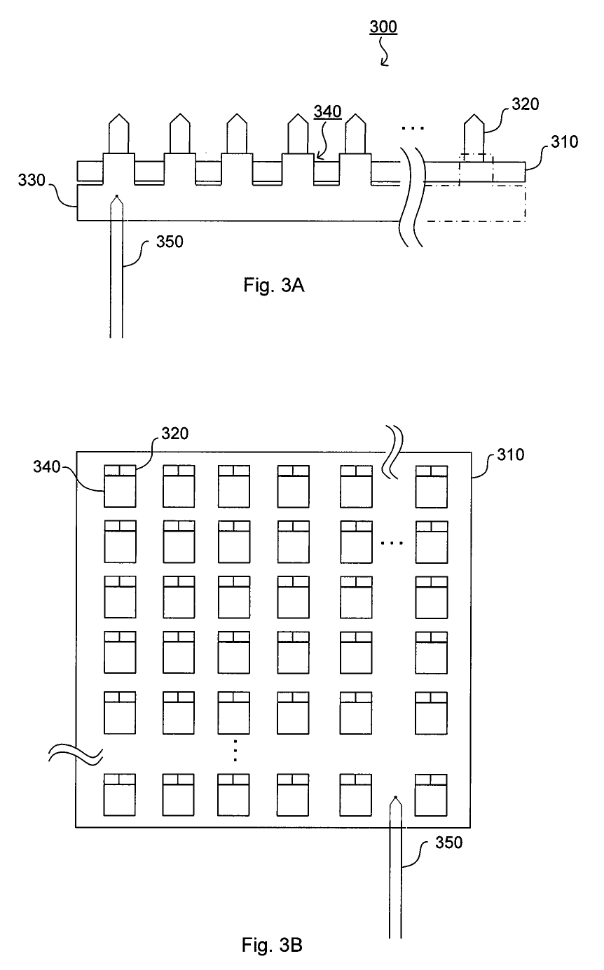

FIGS. 3A-3B are block diagrams that illustrate a preferred embodiment of a consumable medical item 300 comprising a percutaneous electrode array (PEA) that includes an adhesion layer and a resistor. More specifically, item 300 illustrated in FIG. 3A comprises a substrate 310, a plurality of electrodes 320, an adhesion layer 330, and a plurality of voids 340 in substrate 310, and an embedded resistor 350. Adhesion layer 330 is mounted to a rear side of substrate 310 and protrudes through voids 340 in substrate 310. Adhesion layer 330 secures the electrode to the patient, and preferably aids in the conduction of the electrical signal into the body. Substrate 310 provides support for adhesion layer 330.

FIG. 3B depicts a top view of item 300 before application of adhesion layer 330. Electrodes 320 and voids 340 are arranged in a grid pattern. Preferably, array 300 is manufactured from a sheet of stainless steel stamped and/or etched to produce voids 340 and electrodes 320 within the area of voids 340. Electrodes 320 are bended upward so that the major axis is in the desired direction, preferably normal to the surface of substrate 310. Resistor 350 is preferably embedded in substrate 310.

In this preferred embodiment illustrated in FIGS. 3A-3B, information required by the host device is the size and/or surface area of PEA pad 310. This information is indicated by resistor 320 having a particular value and tolerance embedded in pad 310. The host device determines the resistance by measuring the current through resistor 320 at a particular voltage. The value must be within the tolerance set by resistor 320 and measuring electronics. The measured value is used as an index into a lookup table within the host device's data-space and sets the allowed maximum power level.

In an alternative embodiment, a thermistor embedded in the PEA pad indicates, via its range of temperature-dependent resistance, both the pad size and/or surface area of the pad, as well as the pad/skin interface temperature. A second measurement is used as a safety check to prevent possible burns if there is a failure in the integrity of the pad/skin interface. A further extension to this embodiment includes the capability to prevent re-use of a sterile single-use disposable by tracking use time and preventing repeated use by updating the pad's timer appropriately.

In another exemplary embodiment, an intelligent consumable item comprises: a microcontroller; a memory; a read-only memory and additional electronic-derived functionality; and a communications transceiver. The microcontroller communicates with the host device and any additional intelligent consumables. Each consumable has its own capabilities, for example a blood chemistry peripheral, which would work with the host device and/or other attachments to perform a given set of specialized or tailored tasks.

Another exemplary embodiment comprises a set off electrocardiogram (ECG) processing attachments. The raw ECG would be supplied as an analog signal to one attachment. A second attachment could be chosen to facilitate remote transmission from an ambulatory patient back to his bedside monitor. If for instance a particular arrhythmia condition might be present another attachment could perform signal processing to detect a feature within the ECG which signals this condition. Again, this attachment uses the second attachment to convey these data to the patient's bedside and the treatment unit's monitors. Another attachment could be chained to the group to control an external device or if so designed itself, to perform cardio-version to restore sinus rhythm.

There are other uses for the general methods outlined within. An attachment that used a micro-controller could not only sense the attachments physical condition but could also be used to preprocess information that it is being used to detect. This could include digital filtering and local data storage. These attachments, if utilized in an RF mediated power and/or transceiver topology could communicate with one another and the host device enabling a distributed attachment network to both share information and more importantly share resources (each attachment having a specific function) and to share data storage and computational capabilities.

A distributed-processor RF-based network can execute more complex processing tasks that would add redundancy to the attachment group. For example, a set of attachments are being used to measure a collection of physical parameters. If these parameters are noisy or otherwise discontinuous, the attachments could preprocess the data stream to off-load some of the computational burden at the host device. If the host device “is assured” that the incoming data is clean it can operate at a simpler and more reliable level of software complexity. The host device does not need to know what problems exist at the attachments. This mode of operation is analogous to object oriented programming where a known and trusted function existing in software is used without regard to the details of its operation.

If the attachments are designed so that the transceiver and processor can operate independently a failure in a processor could be compensated for by sending the raw data stream from the corrupted attachment to another attachment or set of attachments that would replace the failed processor node's functionality. This takes place transparently to the host device. Additionally, an attachment can be constructed to act as a particular function. Chaining attachments can give the host device the ability to perform additional, different and increasingly more computationally burdensome tasks.

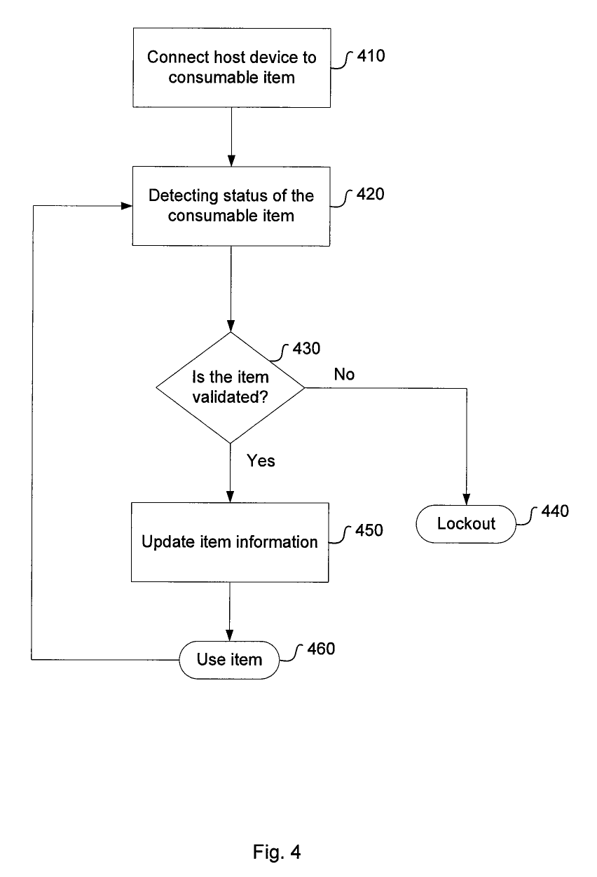

FIG. 4 is a flow chart that illustrates a preferred method of managing the use of a consumable item. As illustrated in FIG. 4, in step 410, the consumable item is connected to the host device. As described above, the connection need not be physical, as there are various wireless and other methods for establishing communications between the host device and the consumable item.

In step 420, the host device obtains status information from the consumable item. The host device may also have a circuit, when connected to the consumable item, that is capable of measuring a physical parameter directly, or the consumable item may make the measurement itself and report the value of the parameter to the host device. The consumable item may report the information automatically when it detects that communications have been established, or it may report the information in response to a request by the host device. As described above, the status information can simply be a resistance that identifies the area of the consumable item, for example. Or it may be other characteristics of the consumable item, or a unique identifier for the consumable item. It may also be more sophisticated information, such as the contents of a memory register that identifies the number of times that the consumable item has been used.

In step 430, the host device carries out processing to determine a course of action based on the information obtained from the consumable item. In an exemplary embodiment, the host device determines whether the consumable item is a validated item that should be used with the host device. In an alternative embodiment, the host device determines whether the consumable item has expired, or has been used beyond a limited number of times. In yet another embodiment, the host device determines whether the consumable item still possesses suitable criteria for its use, based on the physical parameters measured.

If the result the validation process in step 430 results in a determination that the consumable item has not been validated, then in step 440, the host device locks out any further operation until the consumable item has been replaced.

On the other hand, if the validation process in step 430 results in a determination that the consumable item is validated for use, then the method continues to step 450, where information stored in the consumable item is updated. For example, a count of the number of times of use may be incremented and stored in a memory in the consumable item.

Processing proceeds to step 460, where the consumable item is used. For example, in a preferred embodiment, a patient is provided an electric therapy treatment using a gel-based electrode consumable item. The host device may adapt the treatment during use based on the status information received in step 420. In addition, the host device may continue to monitor parameters or information obtained from consumable item during the course of treating the patient. Therefore, steps 420 through 460 may optionally be repeated as many times as necessary, as shown in FIG. 4, while the consumable item is used, until the treatment or use has been completed.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for this invention, but that the invention will include all embodiments falling within the scope of the appended claims.

We claim:

1. A method for managing use of a consumable item, the method comprising:
connecting a host device to the consumable item;
receiving status information from the consumable item at the host device, wherein the status information is based on an electrical property of the consumable item;
determining whether the consumable item is a valid item based on the status information received; and
permitting operation of the host device with the consumable item based on the determination whether the consumable item is a valid item.

2. The method of claim 1, further comprising rejecting the consumable item if the consumable item is an invalid item.

3. The method of claim 1, wherein the status information represents conductivity of the consumable item.

4. The method of claim 1, wherein the status information represents usage of the consumable item.

5. The method of claim 4, wherein the consumable item is validated if a usage limit is not exceeded.

6. The method of claim 5, wherein the usage limit is a number of uses.

7. The method of claim 5, wherein the usage limit is an amount of time of use.

8. The method of claim 1, wherein the status information represents a date of manufacture of the consumable item.

9. The method of claim 1, wherein the determination whether the consumable item is a valid item comprises checking a manufacturer's code to ensure proper quality control standards are met.

10. The method of claim 3, wherein the status information represents a size of the consumable item.

11. The method of claim 1, further comprising adjusting the operation of the host device based on information supplied by the consumable item.

12. An intelligent consumable item comprising:
a microcontroller configured to communicate with a host device, comprising:
a writable memory;
a read-only memory; and
a communications transceiver; and
a device having an electrical property;
wherein the electrical property represents a status of the consumable item.

13. The intelligent consumable item of claim 12, wherein the electrical property represents usage of the consumable item.

14. The intelligent consumable item of claim 12, wherein the electrical property represents a conductivity of the consumable item.

15. The intelligent consumable item of claim 12, wherein information is stored in the consumable item and is communicated to the host device that represents a manufacture date of the consumable item.

16. The intelligent consumable item of claim 15, wherein the microcontroller is further configured to communicate information to another consumable item.

17. The intelligent consumable item of claim 12, further comprising a transducer for monitoring a physiological parameter.

18. The intelligent consumable item of claim 12, further comprising a gel-based electrode.

19. The intelligent consumable item of claim 12, further comprising a percutaneous electrode array.

20. A system for use with an intelligent consumable item, the system comprising:
a host device comprising a programmable interface controller;
a data transfer system; and
a consumable item comprising a memory,
wherein the programmable interface controller is configured to receive information stored in the memory of the consumable item via the data transfer system and to prevent use of the item if the information does not meet predetermined criteria.

21. The system of claim 20, wherein the programmable interface controller updates the memory in the consumable item based on a number of times the item has been used.

22. The system of claim 20, wherein the programmable interface controller adjusts operation of the host device based on the information stored by and received from the consumable item.

23. The system of claim 20, wherein the information stored in the memory of the consumable item indicates a status of the consumable item.

24. The system of claim 20, wherein the predetermined criteria include usage criteria.

25. The system of claim 20, wherein the predetermined criteria include characteristics of the consumable item.
